(19) United States
(12) Patent Application Publication
(10) Pub. No.: US 2026/0299926 A1
(43) Pub. Date: Oct. 1, 2026

(54) SOFTWARE UPDATE SYSTEM, VEHICLE, AND CONTROL METHOD OF VEHICLE

(71) Applicant: HONDA MOTOR CO., LTD., Tokyo (JP)

(72) Inventor: Yasumasa Kaitani, Tokyo (JP)

(21) Appl. No.: 19/566,254

(22) Filed: Mar. 13, 2026

(30) Foreign Application Priority Data
Mar. 27, 2025 (JP) 2025-054076

(51) Int. Cl. G06F 8/65

(52) U.S. Cl. CPC G06F 8/65

(57) ABSTRACT

A software update system including: a vehicle including an electronic control unit; and a server device capable of communicating with the vehicle, wherein the vehicle includes a battery that supplies electric power to the electronic control unit, a software update unit that performs update of software of the electronic control unit, and a battery control unit that performs remaining electric power control of the battery, wherein the software update unit transmits first information inquiring presence or absence of information related to the update of the software to the server device, and receives, from the server device, second information that is a response to the first information, and wherein, in a case where the software update unit has received the second information, the battery control unit changes the remaining electric power control of the battery.

### INCORPORATION BY REFERENCE

The present application claims priority under 35 U.S.C. § 119 to Japanese Patent Application No. 2025-054076 filed on Mar. 27, 2025. The content of the application is incorporated herein by reference in its entirety.

### BACKGROUND OF THE INVENTION

### Field of the Invention

The present invention relates to a software update system, a vehicle, and a control method of a vehicle.

### Description of the Related Art

A technique for updating software in a vehicle including a battery has conventionally been known. For example, Japanese Patent Laid-Open No. 2007-237905 discloses a technique for executing a reprogramming process that rewrites a program of an electronic control device if the voltage of an auxiliary battery that feeds electric power to the electronic control device is equal to or larger than a voltage that allows execution of the reprogramming process.

In update of software in vehicles, it is common practice to perform an activation process of update software. Since the vehicle cannot be used during the activation process, the activation process is performed based on the electric power of the battery of the vehicle. However, the battery of the vehicle is used, for example, for application to improve traveling performance of the vehicle, fuel efficiency of the vehicle, and the like. Therefore, there may be a case where transition to the activation process cannot be made due to lack of remaining electric power of the battery, so that update of software fails.

An object of the present invention, which has been made in view of the above circumstances, is to make it possible to increase the possibility of successful update of the software.

### SUMMARY OF THE INVENTION

One aspect of the present invention is a software update system including: a vehicle including an electronic control unit; and a server device capable of communicating with the vehicle, wherein the vehicle includes a battery that supplies electric power to the electronic control unit, a software update unit that performs update of software of the electronic control unit, and a battery control unit that performs remaining electric power control of the battery, wherein the software update unit transmits first information inquiring presence or absence of information related to the update of the software to the server device, and receives, from the server device, second information that is a response to the first information, and wherein, in a case where the software update unit has received the second information, the battery control unit changes the remaining electric power control of the battery.

According to one aspect of the present invention, it is possible to increase the possibility of successful update of software.

### BRIEF DESCRIPTION OF THE DRAWINGS

FIG. 1 is a diagram showing the configuration of a software update system;

FIG. 2 is a diagram showing the configuration of a server device;

FIG. 3 is a diagram showing the configuration of a vehicle;

FIG. 4 is a sequence diagram showing the operation of the software update device and the server device;

FIG. 5 is a diagram showing an example of a notification screen;

FIG. 6 is a sequence diagram showing the operation of the software update device and the server device;

FIG. 7 is a sequence diagram showing the operation of the software update device and the server device; and

FIG. 8 is a flowchart showing the operation of the software update device.

### DETAILED DESCRIPTION OF THE INVENTION

### 1. First Embodiment

First, a first embodiment will be described.

### 1-1. Configuration of Software Update System

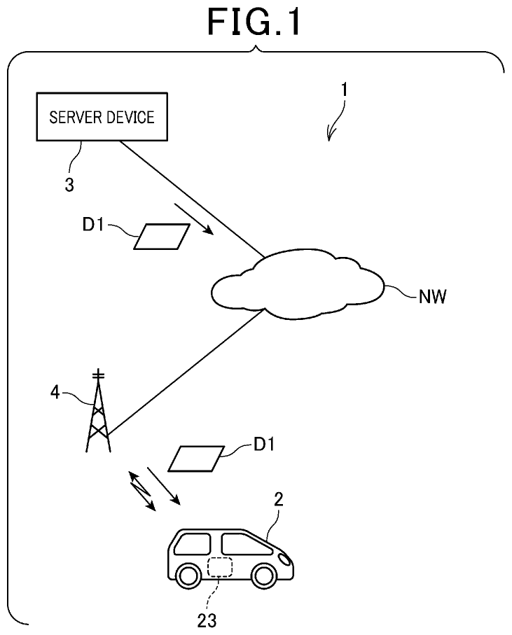

FIG. 1 is a diagram showing the configuration of a software update system 1.

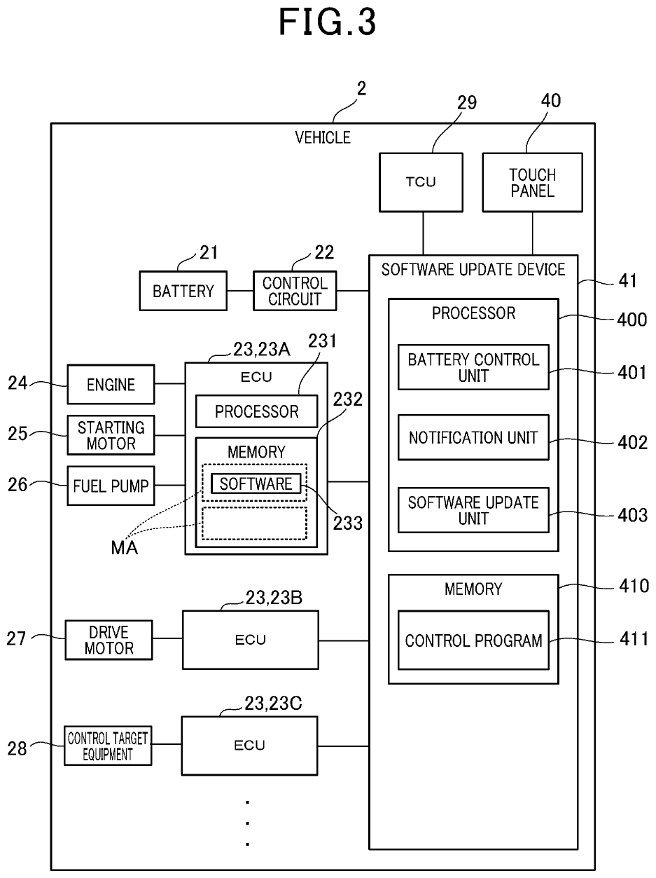

The software update system 1 includes a vehicle 2 and a server device 3 that provides software 233 (see FIG. 3) to be executed by an electronic control unit (ECU) 23 owned by the vehicle 2. The vehicle 2 and the server device 3 are communicatively connected to the vehicle 2 through a communication network NW. The vehicle 2 downloads software for update (hereinafter, with a reference sign “D1” attached thereto, expressed as update software D1) from the server device 3 and updates the software 233 owned by the ECU 23. That is, the software update system 1 enables over-the-air (OTA) update of the software 233 of the vehicle 2.

The ECU 23 is an example of “electronic control units”.

In the following description, the term software includes programs to be executed by a processor and data that is referenced, generated, updated, deleted, and the like in relation to the programs. The expression updating software refers to a process of replacing software to be executed by the processor with software of a newer version, which may be achieved in any specific way that includes addition, deletion, and overwriting of the software. Updating the software may also include processes of deleting some or all of the software to be executed by the processor, installing new software, and deleting, adding, and overwriting data used in the execution of software.

The vehicle 2 of the present embodiment is a hybrid vehicle. The vehicle 2 may be any of a four-wheeled vehicle, a two-wheeled vehicle, and other vehicles, or may be a heavy-duty vehicle, a commercial vehicle, a working vehicle, or the like. As an example, this embodiment describes a four-wheeled vehicle. The vehicle 2 is connected to the communication network NW by wireless communication via, for example, a base station 4 of cellular communication. The specific form of the communication network NW is not limited. For example, the communication network NW may include a cellular communication network, the Internet, a wide area network (WAN), a local area network (LAN), a public network, a provider device, a dedicated line, a base station, and the like.

The server device 3 is a computer connected to the communication network NW via a wired communication line or a wireless communication line and communicatively connected to the vehicle 2. The server device 3 transmits the update software D1 to the vehicle 2.

### 1-2. Configuration of Server Device

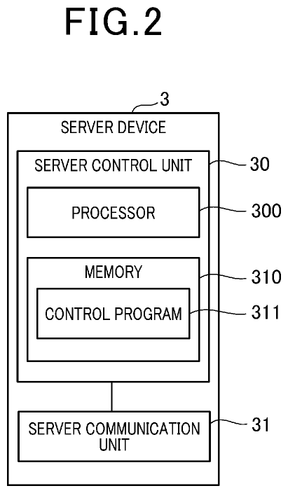

First, with reference to FIG. 2, the configuration of the server device 3 will be described.

FIG. 2 is a diagram showing the configuration of the server device 3.

The server device 3 includes a server control unit 30 and a server communication unit 31.

The server control unit 30 includes a processor 300, such as a central processing unit (CPU), a memory 310, and an interface circuit for connecting other devices and sensors. The server control unit 30 connects with the server communication unit 31. The server control unit 30 reads and executes a control program 311 stored in the memory 310 to perform various operations.

The memory 310 is a storage device storing programs and data. The memory 310 stores the control program 311, data to be processed by the processor 300, and the like. The memory 310 has a nonvolatile storage area. The memory 310 also has a volatile storage area and constitutes a working area for the processor 300. For example, the memory 310 is implemented by a read only memory (ROM) or a random access memory (RAM).

The server communication unit 31 includes hardware such as a communication circuit and communicates with the vehicle 2 as controlled by the server control unit 30.

### 1-3. Configuration of Vehicle

FIG. 3 is a diagram showing the configuration of the vehicle 2.

The vehicle 2 includes a battery 21 and a control circuit 22.

The battery 21 supplies electric power to respective units of the vehicle 2, such as the ECUs 23 and equipment controlled by the ECUs 23 to be described later. The battery 21 connects with the control circuit 22 and is controlled in electric power supply, charging, and the like by the control circuit 22. The control circuit 22 controls the electric power supply of the battery 21 as controlled by the software update device 41.

The vehicle 2 also includes a plurality of ECUs 23.

The ECUs 23 are electronic control devices that control equipment provided in the vehicle 2 and connect to the software update device 41. Each ECU 23 includes a processor 231, such as a CPU, and a memory 232, and controls the connected equipment by the processor 231 reading and executing the software 233 stored in the memory 232. The memory 232 is a storage device storing programs and data. The memory 232 stores the software 233 and data to be processed by the processor 231. The memory 232 is a double bank memory (so-called 2-sided ROM). The memory 232 has a volatile storage area and may constitute a working area for the processor 231.

The vehicle 2 includes, as the ECUs 23, an ECU 23A, an ECU 23B, and a plurality of ECUs 23C.

The ECU 23A is connected to an engine 24, a starting motor 25, and a fuel pump 26. The engine 24 is the driving source of the vehicle 2. The starting motor 25 is a motor that starts the engine 24, and may be a so-called cell motor or a motor/generator having a function to perform regenerative power generation. The fuel pump 26 supplies fuel from a fuel tank of the vehicle 2 to the engine 24. The ECU 23A performs control of the fuel supply to the engine 24, control of the ignition timing in the engine 24, and control of the starting motor 25. Note that the engine 24, the starting motor 25, and the fuel pump 26 are mounted on the vehicle 2.

The ECU 23B is connected to a drive motor 27. The drive motor 27 is the driving source of the vehicle 2 and receives electric power supply from the battery 21 to operate. The ECU 23B controls the rotational speed of the drive motor 27.

Each of the ECUs 23C is connected to one or more control target equipment 28. Examples of the control target equipment 28 include a wiper device that operates the wipers of the vehicle 2, equipment that turns the lights of the vehicle 2 on and off, and the like.

The vehicle 2 includes a telematics control unit (TCU) 29.

The TCU 29 is a communication device that conforms to the communication standard of the vehicle 2 and communicates with devices other than the vehicle 2. The TCU 29 includes, for example, an antenna, a transmitter, a receiver, and the like, and communicates with the server device 3 as controlled by the software update device 41.

The vehicle 2 includes a touch panel 40.

The touch panel 40, which is composed of a display and a touch sensor, accepts a touch operation and displays various types of information.

The vehicle 2 includes the software update device 41.

The software update device 41 is a device that updates the software 233 of the ECUs 23. The software update device 41 includes a processor 400, such as a CPU, a memory 410, and an interface circuit for connecting other devices and sensors. The memory 410 is a storage device storing programs and data. The memory 410 stores a control program 411 and data to be processed by the processor 400. The memory 410 has a nonvolatile storage area. The memory 410 also has a volatile storage area and constitutes a working area for the processor 400. For example, the memory 410 is implemented by a ROM and a RAM.

The processor 400 executes the control program 411 to thereby function as a battery control unit 401, a notification unit 402, and a software update unit 403.

The battery control unit 401 performs remaining electric power control of the battery 21. The battery control unit 401 performs first control or second control as the remaining electric power control of the battery 21.

The first control is control that consumes more electric power of the battery 21 compared with the second control. In the first control, the use rate of the drive motor 27 is made higher than the use rate of the engine 24 as the driving source of the vehicle 2. When executing the first control, the battery control unit 401 instructs the control circuit 22 to increase an electric power supply amount from the battery 21 to the drive motor 27 and instructs the ECUs 23 to decrease the output of the engine 24.

The second control is a control that suppresses electric power consumption of the battery 21 compared with the first control. In the second control, the use rate of the engine 24 is made higher than the use rate of the drive motor 27 as the driving source of the vehicle 2. When executing the second control, the battery control unit 401 instructs the control circuit 22 to decrease the electric power supply amount from the battery 21 to the drive motor 27 and instructs the ECUs 23 to increase the output of the engine 24.

The notification unit 402 displays information on the touch panel 40 to notify the user of the vehicle 2 of the information. The information to be notified by the notification unit 402 will be described later.

The software update unit 403 updates the software 233 owned by the ECUs 23. The software update unit 403 performs a process of inquiring presence or absence of information related to update of the software 233, a process of downloading the update software D1, a process of installing the update software D1 onto the target ECU 23, and a process of causing the ECU 23 to perform the activation process of the update software D1.

### 1-4. Operation

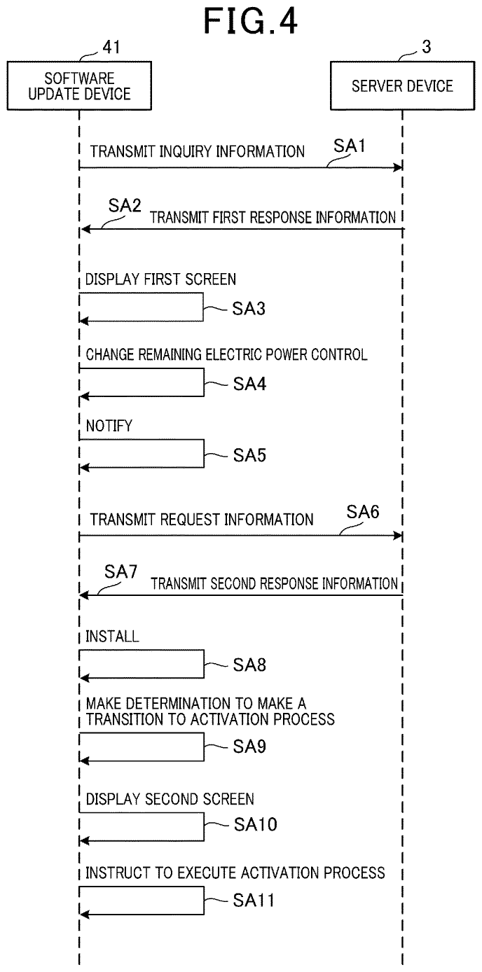

Next, with reference to FIG. 4, the operation related to the update of the software 233 of each unit of the software update system 1 will be described.

FIG. 4 is a sequence diagram showing the operation of the software update device 41 and the server device 3. At the start of operation in FIG. 4, the remaining electric power control of the battery 21 is the first control.

The software update unit 403 transmits inquiry information via the TCU 29 to the server device 3 (step SA1), the inquiry information inquiring presence or absence of information related to the update of the software 233.

The inquiry information is an example of “first information”.

Upon receiving the inquiry information via the server communication unit 31, the server control unit 30 transmits first response information to the vehicle 2 (step SA2).

The first response information is information indicating a response to the inquiry information and information indicating presence or absence of information related to the update of the software 233.

The first response information is an example of “second information”.

The software update unit 403 receives the first response information via the TCU 29, and displays, in a case where the received first response information indicates presence of the update of the software 233, on the touch panel 40 a first screen (step SA3).

The first screen is a screen that inquires the user of the vehicle 2 whether or not to perform update of the software 233. This inquiry to the user is made as required. For example, in the case of software update for the purpose of defect measures, the update may be performed without inquiring the user.

In a case where the first screen instructs to perform update of the software 233, the battery control unit 401 changes the remaining electric power control of the battery 21 from the first control to the second control (step SA4).

Next, the notification unit 402 displays a notification screen TG on the touch panel 40 to notify the user that the remaining electric power control of the battery 21 has been changed (step SA5).

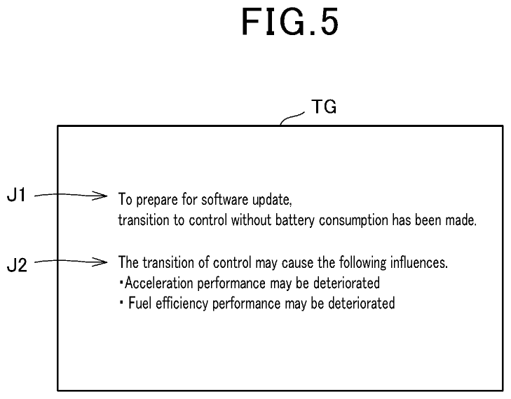

FIG. 5 is a diagram showing an example of the notification screen TG.

The notification screen TG is a screen that notifies the user that the remaining electric power control of the battery 21 has been changed.

The notification screen TG displays reason information J1 and influence information J2.

The reason information J1 is information indicating the reason why the remaining electric power control of the battery 21 has been changed, the reason information corresponding the character string “To prepare for software update” in FIG. 5.

The influence information J2 is information indicating possible influences due to the change made in the remaining electric power control of the battery 21, the influence information corresponding to the character strings “Acceleration performance may be deteriorated” and “Fuel efficiency performance may be deteriorated” in FIG. 5.

Returning to the description of FIG. 4, the software update unit 403 transmits, via the TCU 29, request information to request the update software D1 to the server device 3 (step SA6).

Upon receiving the request information via the server communication unit 31, the server control unit 30 transmits second response information to the vehicle 2 (step SA7).

The second response information is information indicating a response to the request information and includes the update software D1.

Upon receiving the second information from the server device 3, in other words, upon downloading the update software D1 from the server device 3, the software update unit 403 installs the downloaded update software D1 onto the target ECU 23 (step SA8).

To describe step SA8 in detail, the software update unit 403 transfers the update software D1 to the target ECU 23 and instructs the target ECU 23 to write the update software D1 to the memory 232.

As described above, the memory 232 provided in the ECUs 23 is a double bank memory. This enables the ECUs 23 to operate according to the software 233 stored in one storage area MA of the memory 232 while writing the update software D1 to the other storage area MA of the memory 232. Accordingly, the ECUs 23 can write the update software D1 to the memory 232 even when, for example, the vehicle 2 is traveling.

Next, the software update unit 403 determines whether or not to make a transition to the activation process of the update software D1 at the timing when the ignition power source of the vehicle 2 is turned off (step SA9).

Step SA9 will be described in detail.

In the activation process, the use of the vehicle 2 is prohibited. Therefore, the activation process is performed by electric power supply from the battery 21. Accordingly, in a case where the software update unit 403 acquires the remaining electric power of the battery 21 and the acquired remaining electric power of the battery 21 is equal to or larger than predetermined remaining electric power, the software update unit 403 makes affirmative determination in step SA9. This predetermined remaining electric power is appropriately defined by a prior test, simulation, or the like so as to prevent the remaining electric power of the battery from running out in the middle of the activation process.

In a case where the software update unit 403 has determined to make a transition to the activation process, the software update unit 403 displays on the touch panel 40 a second screen that inquires whether or not to start the update of the software (step SA10).

Upon instructed to start the update of the software 233 on the second screen, the software update unit 403 instructs the ECU 23 whose software 233 is to be updated to execute the activation process (step SA11).

Here, the activation process in the ECU 23 will be described.

Upon receiving the instruction to execute the activation process, the ECU 23 performs the activation process of the update software D1. The activation process of the update software D1 includes a process of setting, at the start-up of the ECU 23, startup parameters of the ECU 23 so that the written update software D1 is loaded and control according to the update software D1 is started. For example, the activation process of the update software D1 includes a process of enabling, as a readout area, the storage area MA in which the update software D1 is written and disabling, as a readout area, the storage area MA in which the update software D1 is not written.

In the sequence shown in FIG. 4, in a case where the software update unit 403 has received the first response information from the server device 3, the software update unit 403 may skip the process of step SA3 and perform the process of step SA4 and subsequent processes.

### 2. Second Embodiment

Next, a second embodiment will be described.

In the description of the second embodiment, the same components as those of units of the software update system 1 of the first embodiment will be denoted by the same reference signs and detailed description thereof will be omitted as appropriate.

The second embodiment differs from the first embodiment in the operation related to the update of the software 233.

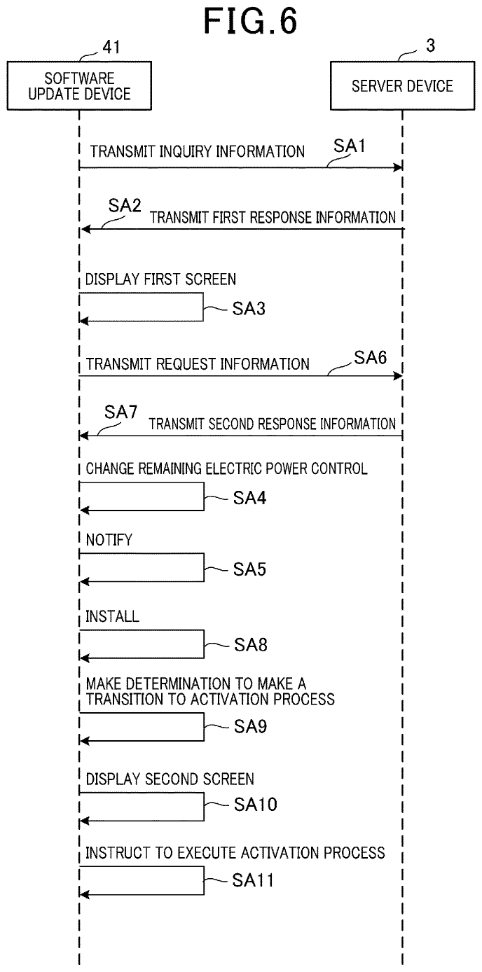

FIG. 6 is a sequence diagram showing the operation of the software update device 41 and the server device 3.

In the sequence diagram shown FIG. 6, steps same as those in the sequence diagram shown in FIG. 4 are denoted by the same step numbers and detailed description thereof will be omitted as appropriate.

At the start of operation in FIG. 6, the remaining electric power control of the battery 21 is the first control.

As the comparison between FIG. 6 and FIG. 4 clearly shows, in the second embodiment, in a case where the update software D1 is downloaded, the software update device 41 changes the remaining electric power control of the battery 21 and notifies that the remaining electric power control of the battery 21 has been changed.

That is, upon instructed to perform update of the software 233 on the first screen, the software update device 41 of the second embodiment performs a process of step SA6 without performing processes of steps SA4 and SA5. Furthermore, in a case where the software update device 41 of the second embodiment has received the second response information, in other words, in a case where the software update device 41 has downloaded the update software D1, the software update device 41 performs steps SA4 and SA5, and then performs the processes of step SA8 and subsequent steps.

Also in the second embodiment, in the sequence shown in FIG. 6, in a case where the software update device 41 has received the first response information from the server device 3, the software update device 41 may skip the process of step SA3.

### 3. Third Embodiment

Next, a third embodiment will be described.

In the description of the third embodiment, the same components as those of units of the software update system 1 of the first embodiment will be denoted by the same reference signs and detailed description thereof will be omitted as appropriate.

The third embodiment differs from the first embodiment in the operation related to the update of the software 233.

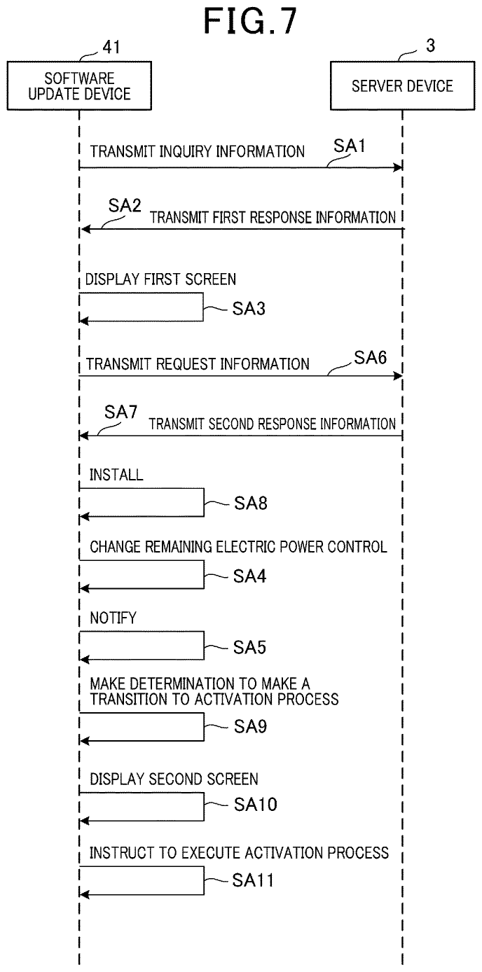

FIG. 7 is a sequence diagram showing the operation of the software update device 41 and the server device 3.

In the sequence diagram shown FIG. 7, steps same as those in the sequence diagram shown in FIG. 4 are denoted by the same step numbers and detailed description thereof will be omitted as appropriate.

At the start of operation in FIG. 7, the remaining electric power control of the battery 21 is the first control.

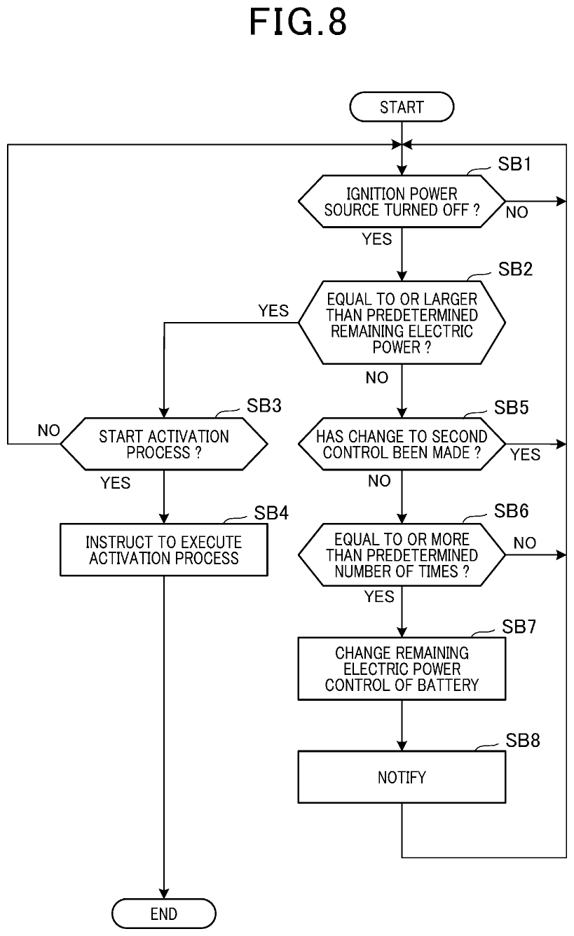

As the comparison between FIG. 8 and FIG. 4 clearly shows, in the third embodiment, in a case where the update software D1 is installed onto the target ECU 23, the software update device 41 changes the remaining electric power control of the battery 21 and notifies that the remaining electric power control of the battery 21 has been changed.

That is, upon instructed to perform update of the software 233 on the first screen, the software update device 41 of the third embodiment performs a process of step SA6 without performing processes of steps SA4 and SA5. Furthermore, in a case where the update software D1 is installed onto the target ECU 23, the software update device 41 of the third embodiment performs steps SA4 and SA5, and then performs the processes of step SA9 and subsequent steps.

Also in the third embodiment, in the sequence shown in FIG. 7, in a case where the software update device 41 has received the first response information from the server device 3, the software update device 41 may skip the process of step SA3.

### 4. Fourth Embodiment

Next, a fourth embodiment will be described.

In the description of the fourth embodiment, the same components as those of units of the software update system 1 of the first embodiment will be denoted by the same reference signs and detailed description thereof will be omitted as appropriate.

The fourth embodiment differs from the first embodiment in the operation related to the update of the software 233.

In the fourth embodiment, until the update software D1 is installed in the target ECU 23, the remaining electric power control of the battery 21 is not changed, and the notification that the remaining electric power control of the battery 21 has been changed is not provided.

FIG. 8 is a flowchart showing the operation of the software update device 41. The flowchart shown in FIG. 8 is performed after the downloaded update software D1 is installed in the target ECU 23.

The software update unit 403 determines whether or not the ignition power source of the vehicle 2 has been turned off (step SB1). In a case where the software update unit 403 has determined that the ignition power source has not been turned off (step SB1: NO), the software update unit 403 performs the process of step SB1 again.

On the other hand, in a case where the software update unit 403 has determined that the ignition power source has been turned off (step SB1: YES), the software update unit 403 determines whether or not the remaining electric power of the battery 21 is equal to or larger than the predetermined remaining electric power (step SB2). Note that this predetermined remaining electric power is remaining electric power of the battery 21 that is enough for the activation process, and is appropriately defined by a prior test, simulation, or the like.

In a case where the software update unit 403 has determined that the remaining electric power of the battery 21 is equal to or larger than the predetermined remaining electric power (step SB2: YES), the software update unit 403 determines whether or not to start the activation process (step SB3).

Step SB3 will be described in detail.

In a case where an operation to start the activation process has been input on the second screen, the software update unit 403 makes affirmative determination in step SB3. On the other hand, in a case where an operation not to start the activation process has been input on the second screen or in a case where an operation to start the activation process has not been input on the second screen for a predetermined time or more, the software update unit 403 makes negative determination in step SB3.

In a case where the software update unit 403 has determined not to start the activation process (step SB3: NO), the processor 400 returns the process to step SB1.

On the other hand, in a case where the software update unit 403 has determined to start the activation process (step SB3: YES), the software update unit 403 instructs the ECU 23 in which the update software D1 has been installed to execute the activation process (step SB4).

Returning to the description of step SB2, in a case where the software update unit 403 has determined that the remaining electric power of the battery 21 is not equal to or larger than the predetermined remaining electric power (step SB2: NO), the battery control unit 401 determines whether or not the remaining electric power control of the battery 21 has been changed to the second control (step SB5).

In a case where it has been determined that the battery control unit 401 has made change to the second control (step SB5: YES), the processor 400 performs determination of step SB1 again.

On the other hand, in a case where the battery control unit 401 determines that the change to the second control has not been made (step SB5: NO), the battery control unit 401 determines whether or not the number of times transition to the activation process has not been successfully made due to the lack of remaining electric power of the battery 21 is equal to or more than a predetermined number of times (step SB6).

Step SB6 will be described in detail.

After the start of the flowchart of FIG. 8, the battery control unit 401 counts the number of times negative determination has been made in step SB2. In a case where the number of times negative determination has been made in step SB2 is equal to or more than a predetermined number of times, the battery control unit 401 makes affirmative determination in step SB6. Note that the case of making affirmative determination in step SB6 is a case where the transition to the activation process has not been successfully made due to insufficient remaining electric power of the battery 21 during driving cycles of a predetermined number of times. Note that the driving cycle refers to the period from when the ignition power source is turned on until the ignition power source is turned off.

On the other hand, in a case where the number of times negative determination has been made in step SB2 is not equal to or more than the predetermined number of times, the battery control unit 401 makes negative determination in step SB6.

Subsequently, in a case where the battery control unit 401 has made negative determination is step SB6 (step SB6: NO), the processor 300 returns the process to step SB1.

On the other hand, in a case where the battery control unit 401 has made affirmative determination in step SB6 (step SB6: YES), the battery control unit 401 changes the remaining electric power control of the battery 21 from the first control to the second control (step SB7).

Next, the notification unit 402 notifies that the remaining electric power control of the battery 21 has been changed (step SB8).

### 5. Other Embodiments

The above-described embodiment merely shows an aspect thereof, and can be modified and applied as required.

In the embodiment described above, the case where the vehicle 2 is a hybrid vehicle is exemplified. However, the vehicle 2 may be not a hybrid vehicle but an electric vehicle in which the engine 24 is not mounted. In other embodiments, by changing the electric power supply destination of the battery 21, the remaining electric power control of the battery 21 is changed from the first control to the second control. In other embodiments, the vehicle 2 is not provided with the ECU 23A and equipment controlled by the ECU 23A.

In the embodiments described above, the notification unit 402 is configured to perform notification by displaying information. In other embodiments, the notification unit 402 may perform notification by voice. In such case, the vehicle 2 includes a speaker that outputs sound in the vehicle interior.

The processors 231, 300, and 400 may be implemented by a plurality of processors or may be implemented by a single processor. These processors may be hardware programmed to implement the functional units described above. In such case, these processors are implemented by, for example, an application specific integrated circuit (ASIC) or a field programmable gate array (FPGA).

The internal configuration of the vehicle 2 shown in FIG. 3 is an example, and the specific implementation is not particularly limited. In other words, hardware individually corresponding to each unit is not necessarily implemented, and it is of course possible to adopt a configuration in which a single processor executes a program to thereby implement the functions of respective units. Furthermore, a part of the functions implemented by software in the above-described embodiment may be provided as hardware, or a part of the functions implemented by the hardware may be implemented by the software.

The operational step units shown in FIG. 4 and FIGS. 6 to 8 are obtained by dividing a process according to its main contents. The present invention is not limited by how to divide the process into units or how to name the divided units. The process may be further divided into more step units according to its contents. The process may also be divided so that one step unit includes more processes. The order of the steps may be changed as appropriate within a range that does not depart from the spirit of the present invention.

In a case where the system update method by the software update device 41 described above is implemented by using the processor 400, the program to be executed by the processor 400 can also be configured in the form of a recording medium or a transmission medium that transmits the program. That is, the control program 411 can also be implemented by a portable information recording medium with the control program 411 recorded thereon. Examples of the information recording medium include magnetic recording media such as a hard disk, optical recording media such as a CD, and semiconductor storage devices such as a universal serial bus (USB) memory and a solid state drive (SSD), but other recording media can also be used.

### 6. Configurations Supported by the Above Embodiments

The above embodiments support the following configurations.

### (Configuration 1)

A software update system including: a vehicle including an electronic control unit; and a server device capable of communicating with the vehicle, wherein the vehicle includes a battery that supplies electric power to the electronic control unit, a software update unit that performs update of software of the electronic control unit, and a battery control unit that performs remaining electric power control of the battery, wherein the software update unit transmits first information inquiring presence or absence of information related to the update of the software to the server device, and receives, from the server device, second information that is a response to the first information, and wherein, in a case where the software update unit has received the second information, the battery control unit changes the remaining electric power control of the battery.

According to the software update system of Configuration 1, the remaining electric power control of the battery is changed in a case where the update of the software is anticipated. Therefore, the remaining electric power of the battery can be controlled before the activation process so as not to become remaining electric power that does not allow transition to the activation process. Therefore, it is possible to reduce the possibility that transition to the activation process cannot be made due to the lack of remaining electric power of the battery, and it is possible to increase the possibility of successful update of the software.

### (Configuration 2)

The software update system according to Configuration 1, wherein the battery control unit changes the remaining electric power control of the battery in a case where the software update unit has downloaded update software after receiving the second information.

According to the software update system of Configuration 2, the remaining electric power control of the battery is changed in a case where the update of the software is likely to be performed. Therefore, the remaining electric power of the battery can be controlled before the activation process so as not to become remaining electric power that does not allow transition to the activation process. Therefore, it is possible to reduce the possibility that transition to the activation process cannot be made due to the lack of remaining electric power of the battery, and it is possible to increase the possibility of successful update of the software. Furthermore, the remaining electric power control of the battery is changed in a case where the update software has been downloaded. Therefore, an influence of the remaining electric power control of the battery having been changed is prevented from affecting the vehicle before the update software is downloaded.

### (Configuration 3)

The software update system according to Configuration 2, wherein the battery control unit changes the remaining electric power control of the battery in a case where the electronic control unit has installed the update software.

According to the software update system of Configuration 3, the remaining electric power control of the battery is changed in a case where the update of the software is likely to be performed. Therefore, the remaining electric power of the battery can be controlled before the activation process so as not to become remaining electric power that does not allow transition to the activation process. Therefore, it is possible to reduce the possibility that transition to the activation process cannot be made due to the lack of remaining electric power of the battery, and it is possible to increase the possibility of successful update of the software. Furthermore, the remaining electric power control of the battery is changed in a case where the update software has been installed. Therefore, an influence of the remaining electric power control of the battery having been changed is prevented from affecting the vehicle before the update software is installed. That is, it is possible to prevent the influence from affecting the vehicle over a long period.

### (Configuration 4)

The software update system according to Configuration 3, wherein the battery control unit changes the remaining electric power control of the battery in a case where, after the update software is installed, transition to an activation process of the update software has not been successfully made due to lack of remaining electric power of the battery during driving cycles of a predetermined number of times.

According to the software update system of Configuration 4, it is possible to prevent the influence of the remaining electric power control of the battery having been changed from affecting the vehicle over a long period after the update software is installed.

### (Configuration 5)

The software update system according to any one of Configurations 1 to 4, further including a notification unit that notifies, in a case where the battery control unit has changed the remaining electric power control of the battery, a user of the vehicle that the remaining electric power control of the battery has been changed.

According to the software update system of Configuration 5, even if the influence of the remaining electric power control of the battery having been changed affect the vehicle, it is possible to prevent the user of the vehicle from feeling discomfort with occurrence of the influence.

### (Configuration 6)

The software update system according to Configuration 5, wherein the notification unit notifies a reason why the remaining electric power control of the battery has been changed and a possible influence of the remaining electric power control of the battery having been changed.

According to the software update system of Configuration 6, even if the influence of the remaining electric power control of the battery having been changed affect the vehicle, it is possible to further suppress the user of the vehicle from feeling discomfort with the occurrence of the influence.

### (Configuration 7)

A vehicle that has an electronic control unit and is capable of communicating with a server device, the vehicle including: a battery that supplies electric power to the electronic control unit; a software update unit that performs update of software of the electronic control unit; and a battery control unit that performs remaining electric power control of the battery, wherein the software update unit transmits first information inquiring presence or absence of information related to the update of the software to the server device, and receives, from the server device, second information that is a response to the first information, and wherein, in a case where the software update unit has received the second information, the battery control unit changes the remaining electric power control of the battery.

According to the vehicle of Configuration 7, the same effect as the software update system of Configuration 1 is achieved.

### (Configuration 8)

A control method of a vehicle that has an electronic control unit and a battery that supplies electric power to the electronic control unit, the vehicle capable of communicating with a server device, the control method including: transmitting first information inquiring presence or absence of information related to update of software owned by the electronic control unit to the server device, receiving, from the server device, second information that is a response to the first information, and changing, in a case where the second information has been received, remaining electric power control of the battery.

As controlled method of a vehicle of Configuration 8, the same effect as the software update system of Configuration 1 is achieved.

### REFERENCE SIGNS LIST

1 software update system
2 vehicle
3 server device
4 base station
21 battery
22 control circuit
23, 23A, 23B, 23C electronic control unit (ECU)
24 engine
25 starting motor
26 fuel pump
27 drive motor
28 control target equipment
29 TCU
30 server control unit
31 server communication unit
40 touch panel
41 software update device
231 processor
232 memory
233 software
300 processor
310 memory
311 control program
400 processor
401 battery control unit
402 notification unit
403 software update unit
410 memory
411 control program
D1 update software
J1 reason information
J2 influence information
MA storage area
NW communication network
TG notification screen

1. A software update system comprising:
a vehicle including an electronic control unit; and
a server device capable of communicating with the vehicle,
wherein the vehicle includes
a battery that supplies electric power to the electronic control unit,
a software update unit that performs update of software of the electronic control unit, and
a battery control unit that performs remaining electric power control of the battery,
wherein the software update unit
transmits first information inquiring presence or absence of information related to the update of the software to the server device, and
receives, from the server device, second information that is a response to the first information, and
wherein, in a case where the software update unit has received the second information, the battery control unit changes the remaining electric power control of the battery.

2. The software update system according to claim 1, wherein
the battery control unit changes the remaining electric power control of the battery in a case where the software update unit has downloaded update software after receiving the second information.

3. The software update system according to claim 2, wherein
the battery control unit changes the remaining electric power control of the battery in a case where the electronic control unit has installed the update software.

4. The software update system according to claim 3, wherein
the battery control unit changes the remaining electric power control of the battery in a case where, after the update software is installed, transition to an activation process of the update software has not been successfully made due to lack of remaining electric power of the battery during driving cycles of a predetermined number of times.

5. The software update system according to claim 1, further comprising
a notification unit that notifies, in a case where the battery control unit has changed the remaining electric power control of the battery, a user of the vehicle that the remaining electric power control of the battery has been changed.

6. The software update system according to claim 5, wherein
the notification unit notifies a reason why the remaining electric power control of the battery has been changed and a possible influence of the remaining electric power control of the battery having been changed.

7. A vehicle that has an electronic control unit and is capable of communicating with a server device, the vehicle comprising:
a battery that supplies electric power to the electronic control unit;
a software update unit that performs update of software of the electronic control unit; and
a battery control unit that performs remaining electric power control of the battery,
wherein the software update unit
transmits first information inquiring presence or absence of information related to the update of the software to the server device, and
receives, from the server device, second information that is a response to the first information, and
wherein, in a case where the software update unit has received the second information, the battery control unit changes the remaining electric power control of the battery.

8. A control method of a vehicle that has an electronic control unit and a battery that supplies electric power to the electronic control unit, the vehicle capable of communicating with a server device, the control method comprising:
transmitting first information inquiring presence or absence of information related to update of software owned by the electronic control unit to the server device,
receiving, from the server device, second information that is a response to the first information, and
changing, in a case where the second information has been received, remaining electric power control of the battery.
